(19) United States
(12) Patent Application Publication
(10) Pub. No.: US 2012/0173534 A1
(43) Pub. Date: Jul. 5, 2012

(54) AUTOMATED DETERMINATION AND/OR PROCESSING OF INFORMATION

(76) Inventors: Michael Keil, Koeln (DE); Volodymyr Vynogradov, Koeln (DE); Julia Vynogradova-Reckert, Koeln (DE)

(21) Appl. No.: 13/345,521

(22) Filed: Jan. 6, 2012

Related U.S. Application Data
(63) Continuation of application No. PCT/EP2010/004083, filed on Jul. 6, 2010.

(30) Foreign Application Priority Data
Jul. 6, 2009 (DE) 10 2009 031 970.0

(51) Int. Cl. G06F 17/30; G06F 15/16

(52) U.S. Cl. 707/740; 707/754; 707/E17.046

(57) ABSTRACT

A data processing system and method for automated retrieval and/or processing of information from a plurality of available data sources in a computer network, whereby the information is input or will be input in objects structured in modules, at least one property related to the information is assigned or will be assigned to the information in the modules of the object (property assignment), a comparison is performed of at least two objects (object comparison) by comparing at least one of the modules of a first object of at least two objects with at least one module of at least one other object of at least two objects, and the result of the comparison of the objects is presented as information.

### CROSS-REFERENCE TO RELATED APPLICATIONS

The present application is a continuation of pending International patent application PCT/EP2010/004083 filed on Jul. 6, 2010 which designates the United States and claims priority from German patent application 10 2009 031 970.0 filed on Jul. 6, 2009, the content of which is incorporated herein by reference.

### FIELD OF THE INVENTION

The present invention relates to a method and data processing system for automated retrieval and processing of information from a plurality of available data sources in a computer network.

### BACKGROUND OF THE INVENTION

Methods, systems and devices for automated retrieval and processing of data from a plurality of available data sources in a computer network are known under various forms and for different applications within the framework of the currently available technology, e.g. from DE 103 16 298 A1, DE 10 2005 002 619 A1, DE 10 2007 042 093 A1, DE 10 2007 042 080 A1 or WO 2008/039868 A2. The relevant methods, systems and/or devices are applied, in particular, within the framework of the so-called portals in communication networks, such as the Internet.

In terms of the above-mentioned invention, a portal is thereby an application system, which is characterised, in particular, by the integration of applications, processes and/or services. A portal thereby gives the user an advantage and provides various functions and functionalities at his/her disposal, such as for example, personalisation, reliability, navigation, user administration and/or similar functions and functionalities. Moreover, the portals are usually developed and/or designed, so as to coordinate the search and/or presentation of information. It is particularly characteristic for the portals to link and exchange data between heterogenic applications on the portal platform, which facilitate a central access to personal contents and tailor-made access to applications, processes and/or services.

Internet users are often confronted with an almost unmanageable amount of information which rarely provides the right or desired answers for specific questions of the respective Internet users. Therefore, the growing demand of the Internet user for information is not actually satisfied. The following problems can be mentioned, in particular:
excessive information and disorientation;
diversity and fragmentation of contents;
spending a lot of time to find, record and comprehend information which is really relevant;
low quality of search engines listings;
user's demand for quality and order;
search engines provide mostly plausible results, but generally not always the best ones;
higher market dynamics bring and substantiate much shorter periods of marketing concept validity and require the greatest possible flexibility regarding the budget.

Various portals on the Internet provide different solutions for automated retrieval and/or processing of information. These include, in particular, new forms of search engines, evaluation and/or comparison portals. The information is usually systematized there and the plausible results are shown, but their selection and quantity is often so large that further searches are often required to evaluate the information. The information acquisition, which has been known so far, is still too time-consuming.

In particular, the disadvantage of the portals, which have been commercially available so far, consists in the need to perform rigidly structured comparisons to determine and process information, where only individual specific information contents, such as items, products, trips, retailers and/or similar contents are compared or comparable with one another. A universal dynamic comparison is not possible.

Moreover, the previously known portals and portal applications bring various disadvantages and/or limitations to the user, in particular, regarding a convenient handling and operation, possibilities for presenting data, interaction possibilities and/or user individualization. What is more, the entire structure and/or development of information are not systematically demonstrated as a whole.

With reference to this background, the present invention has been developed for the purpose of improving the automated retrieval and/or processing of data from a plurality of available sources in a computer network, in particular, regarding the convenient handling and operation, possibilities of presenting data and/or user individualization within the framework of the portal and/or portal application.

### SUMMARY OF THE INVENTION

In order to provide a technical solution for this task, the invention offers a method and data processing system for automated retrieval and/or processing of data from a plurality of available sources in a computer network, whereby the information is or becomes recorded in objects structured in modules. At least one property regarding the information is or becomes associated with the information in the modules of the objects (property assignment), at least two objects are compared (object comparison) by comparing at least one of the modules of a first object from at least two objects with at least one module of at least one further object from at least two objects, and the result of the object comparison is presented as information.

The invention relies on the knowledge that advantageous universal and individualised object comparisons can be performed by means of the invention-based recording of data in objects structured in modules according to property assignment and invention-based object comparison at module levels, such object comparisons ensuring further refinement of information. The refinement of information in terms of the present invention includes, among other, services such as compilations of information from different sources, comparisons, systematized and application-related presentations of information, compression of information so that the user does not have to review the original sources, as well as quality indications and action relevance as regards information. Thanks to the invention, it is possible to reduce the costs involved in information acquisition and to optimize information acquisition, so that the convenient application and/or operation, information presentation and/or user individualisation, especially within the framework of portals or portal applications, are improved. The portal developed and equipped according to the invention provides the advantage of a universally applicable module-based information procedure, which structures the contents of all formats in a new way and shows the interactions between the individual elements of data. The invention provides an advantage in the ordering, evaluating and/or interactively comparing topics, events, persons, products and/or services. Another advantage is that the organizations and individuals, professionals and non-professionals, companies and/or customers can participate in a structured dialogue at the so-called “point of interest”. The dialogue is factual, argumentative, involving, but also relies on the so-called “fun and experience factor”.

The architecture of the invention-based platform provides more transparency, order and a more precise handling of the information. Instead of a simple sum of individual units, the data is conveniently provided in a clearly comprehensible format and in a more useful and concrete manner, which contributes, in particular, to forming opinions, democratization and/or finding a solution. Thanks to the integrated approach based on the invention, the user can avoid the danger of consuming too many “info-snacks” and as a result, receiving too much information of low value.

Thanks to the invention, all kinds of comparisons the user can think of are possible to specify and feasible. Further, the resulting comparisons give the user an advantage of gaining knowledge. Another advantage is that invention-based comparisons allow to identify phenomena, which would not be identifiable in the analysis of individual cases or would lack the country-specific perspective.

In terms of the present invention, an object represents an individual and identifiable set of items, persons or concepts originating from the real world or the world of ideas, problem statements and/or decision-making situations. For example, FIG. 1 shows what is an object in terms of the present invention, namely an individual such as female politician, actress, entrepreneur, show participant or a similar person, a real object such as a book, car or another favourite product, an abstract concept related to topics such as sustainability, democracy, criminality, tax evasion and similar topics, an event such as political summit, Olympic games, European football championships, Eurovision broadcast or similar events, a relation between at least two objects such as, for example, size proportion between buildings, a result such as the result of a political reform, railway privatisation, result of a study and similar results. Based on the invention, the object constitutes at the same time the point of origin and cross-linking point for all relevant information. According to the invention, the functionalities, in particular, modules and/or applications help to generate specified topics from the knowledge based on shared information.

An advantageous form of the invention is characterised by an assignment of objective and/or subjective properties within the framework of property assignment. The criteria and/or specifications of objective properties conveniently describe technical, physical or similar features of an object. For example, an objective property of the object such as “university” could be its founding year, enrolment fee or semester fee. Such properties can be objectively verified and measured. For the purpose of applying subjective properties, the user is conveniently provided with subjective interpretation possibilities regarding the properties of an object and/or criteria, for example, assistance quality or studying atmosphere. Further, the properties, criteria and/or specifications can be conveniently modified, especially according to individual needs.

A particularly advantageous form of the invention is that evaluation criteria can be recorded in many languages, directly or at a later point in time, within the framework of property assignment, especially in a way which allows for international comparability of information, even if the user cannot speak or read foreign languages.

Another advantageous form of the invention is that the information in the modules can be or can become recorded in grouped units. The advantage, which results from this process, is that normally numerous properties or criteria are brought together or divided I logical groups. For example, the “objective criteria” module of a university object contains the “general information” group, criteria such as type of university, founding year or number of students. Further groups such as, for example, university sport, city information, university ranking, Nobel Prize winners and similar groups contain the criteria assigned respectively.

Another advantageous form of the invention is that results delivered from all modules are presented in the same form. FIG. 7 shows an example of data delivered according to the invention.

It is an advantage that the object comparison is performed by a comparison of at least one module group and/or at least one module unit, where identical module groups and/or units are compared with one another.

It is an advantage that the property assignment results from taking into consideration of geographical classification parameters, semantic classification parameters, socio-demographic classification parameters and/or classification parameters for administration of user rights to the information.

According to an advantageous proposal, the invention performs a filtered object comparison, especially with consideration to geographical parameters, socio-demographic parameters, object-related parameters, semantic parameters and parameters based on experiments. This creates a possibility for differentiated and/or individual consideration of a particular object. For example, if the user would like to compare only the opinions of women living in France, he/she can set the relevant filter envisaged for this purpose.

The result of object comparison is advantageously recorded as information. The result of an invention-based object comparison generates a new information product which is supplied with an identification code. Third party websites can be accessed by the link or code regarding the information product, for example, to review or recall the comparison results once again, at a later point in time, without the need to prompt information retrieval or reset the filter.

Another advantageous form of the invention is that the result of object comparison is shown as information, preferably in graphical form, particularly preferred with at least one piece of time-related information and/or a correlation between information from object comparison.

Another advantageous form of the invention is characterised by grouping objects for object comparison.

It is an advantage that an object comparison is provided with at least one module, preferably with at least one information module, at least one multimedia module, at least one module of objective criteria based on technical features and/or physical features, at least one module of subjective criteria, at least one discussion module, at least one concept module, at least one chronology module, at least one relationship module and/or at least one strategy and/or tactics module. Another advantageous form of the invention is that further modules, especially modules with the so-called third party applications, that is, special applications of other providers can be conveniently integrated in any number.

The invention-based information module is advantageously divided into two parts. The first part (part 1) contains information, articles, so-called blogs and/or related objects provided by visitors. The second part (part 2) covers official information regarding a particular object. For example, the “University of Cologne” object presents only the University of Cologne here.

All media contents and/or formats are brought together and/or recalled in the invention-based multimedia module. The modules of objective and subjective criteria advantageously facilitate multi-language criteria and/or group creation. Moreover, the modules of objective and subjective criteria with related functions such as, for example, group creating and/or group sorting, facilitate performing evaluation properties adjustments and/or obtaining selection possibilities for invention-based object comparison.

The invention-based discussion module conveniently facilitates dialogues and/or discussions in a structured form, concerning a particular discussion point (X1 to Xn), related to the reflected or represented opinions, statements and/or theses, for the purpose of controlling their direction and scope (to keep them on track), whereby particular opinions and/or statements relating to the discussion point (X) are conveniently divided into arguments “for” and “against”. A particular opinion pattern per discussion point (X) is advantageously visualised graphically percentage-wise by means of evaluation option (for and against).

The proposals and/or concepts can be submitted and/or commented in the invention-based concept module. Moreover, the proposals and/or concepts can be advantageously visualised by means of graphical applications additionally in the form of graphics or sketches. The concepts are conveniently evaluated as “good” or “bad”, according to the evaluation option.

With the help of the invention-based chronology module all time categories from minute to century time dimension can be advantageously presented on a resizable or zoomable time axis. Particular named or selected points in time or time intervals are advantageously presented according to the topic or time, whereby the presented topics and/or events can be additionally visualised or positioned on the time axis by means of assigning icons from a selection list and own icons. Any number of chronologies can be advantageously created.

In the invention-based relationship module, the objects and/or their relations are advantageously shown within the user interface and their interrelations are displayed. The stronger the relationship between the objects is the stronger and thicker is the presented line which links the presented objects. Upon selecting the invention-based relationship line, for example, by the so-called click-on or clicking the relationship line, relevant information on the relationship between objects (for example object X and object Y) is shown. One can advantageously create any number of objects and/or relationships existing between them. Depending on the object type, a particular object is presented with an icon belonging to its respective category.

Advantageously structured strategies can be created and/or developed with the help of the invention-based strategy and/or tactics modules. Thanks to programme components and/or elements, particular strategy elements are advantageously generated and evaluated by means of the so-called scoring procedure. Moreover, tactical influence factors regarding the strategy can be presented in an advantageously and relevant manner.

A particularly advantageous form of the invention provides that the information recorded in objects with a modular structure is at least partially distributed on different computers, preferably in computer stations of a segmented computer network, and stored there, whereby at least one interval with unambiguous object numbers is assigned to at least each segment, the information recorded in modularly structured objects is provided with the available object numbers, and the modularly structured objects provided with object numbers are stored on the side of the respective segments, and for performing the object comparison a computer of the computer network preferably designed preferably as a web server undertakes an object comparison of the modules by querying the segments, the result of the object comparison of the modules is recorded preferably by the computer of the computer network designed as a web server and is merged to form the result of the object comparison. An implementation example of results, according to the invention, is presented in FIG. 10.

The storage, processing and/or management of a virtually unlimited number of objects are made possible thanks to the proposed use, according to the invention, of a distributed architecture of computers in a computer network. On the whole, the functionality of the method or the data processing system according to the invention is further improved in this way, especially in view of the otherwise existing storage capacity problems and/or load sharing problems.

A data processing system according to the invention is advantageously designed and/or provided; a method according to the invention must be executed at least partially.

### BRIEF DESCRIPTION OF THE DRAWINGS

Further details, features and advantages of the invention are explained in closer detail below by the means of the description of the illustrative implementations presented in the figures of the drawing. The following are shown:

FIG. 1 in a graphically designed table, an overview of objects in the sense of the present invention;

FIG. 2 in a schematic diagram, an illustrative implementation example of the recording of information according to the invention in objects structured in modules;

FIG. 2a in a schematic diagram, an illustrative implementation example of a composition of modules and single applications according to the invention;

FIG. 2b in a schematic diagram, an illustrative implementation example of the use of modules according to the invention for processing of the information according to the invention;

FIG. 2c in a schematic diagram, an illustrative implementation example of application possibilities and/or areas of application of a retrieval and/or processing of information according to the invention;

FIG. 3 an illustrative implementation example of a user interface, according to the invention, for the input, output and/or management of the retrieval and/or processing of information, according to the invention, from a plurality of available data sources in a computer network;

FIG. 4 an illustrative implementation example of a user interface, according to the invention, for the input, output and/or management of the retrieval and/or processing of information, according to the invention, from a plurality of available data sources in a computer network according to FIG. 3;

FIG. 5 in a schematic diagram, a further illustrative implementation example of a user interface, according to the invention, for the input, output and/or management of the retrieval and/or processing of information, according to the invention, from a plurality of available data sources in a computer network in connection with an object comparison according to the invention;

FIG. 6 in a schematic diagram, a further illustrative implementation example of a user interface, according to the invention, for the input, output and/or management of the retrieval and/or processing of information, according to the invention, from a plurality of available data sources in a computer network in connection with an object comparison, according to the invention, in accordance with FIG. 5;

FIG. 7 in a schematic diagram, a further illustrative implementation example of a log of results, according to the invention, of the retrieval and/or processing of information, according to the invention, from a plurality of available data sources in a computer network;

FIG. 8 in a schematic diagram, an illustrative implementation example of a log of results during time intervals, according to the invention, of the retrieval and/or processing of information, according to the invention, from a plurality of available data sources in a computer network;

FIG. 9 in a schematic diagram, an illustrative implementation example of a data processing system, according to the invention, for the retrieval and/or processing of information, according to the invention, from a plurality of available data sources in a computer network;

FIG. 10 in a further schematic diagram, an illustrative implementation example of a data processing system, according to the invention, for the retrieval and/or processing of information, according to the invention, from a plurality of available data sources in a computer network;

FIG. 11 in a schematic diagram, an illustrative implementation example of the structure, according to the invention, of a comparison according to the invention;

FIG. 12 in a schematic diagram, an illustrative implementation example, according to the invention, of available filter options and their structuring;

FIG. 12a in a schematic diagram, an illustrative implementation example of an object creation or modification by means of modules, according to the invention, in the present case in a condition prior to a modification;

FIG. 12b in a schematic diagram, an illustrative implementation example of an object creation or modification by means of modules, according to the invention, in the present case in a condition after a modification according to FIG. 12a;

FIG. 12c in a schematic diagram, a further illustrative implementation example of an object creation or modification by means of modules, according to the invention; and

FIG. 12d in a schematic diagram, a further illustrative implementation example of an object creation or modification by means of modules, according to the invention.

### DETAILED DESCRIPTION OF THE INVENTION

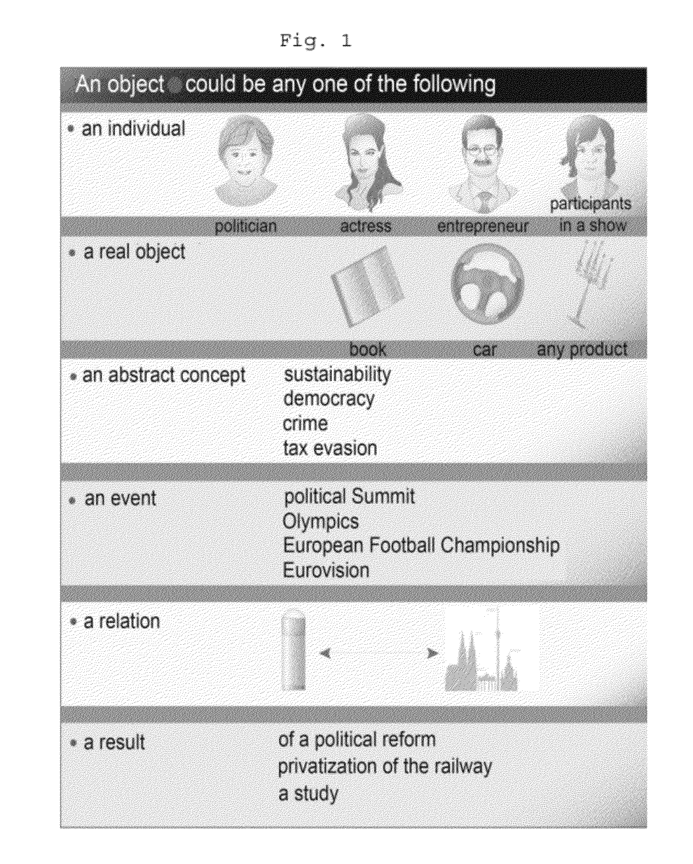

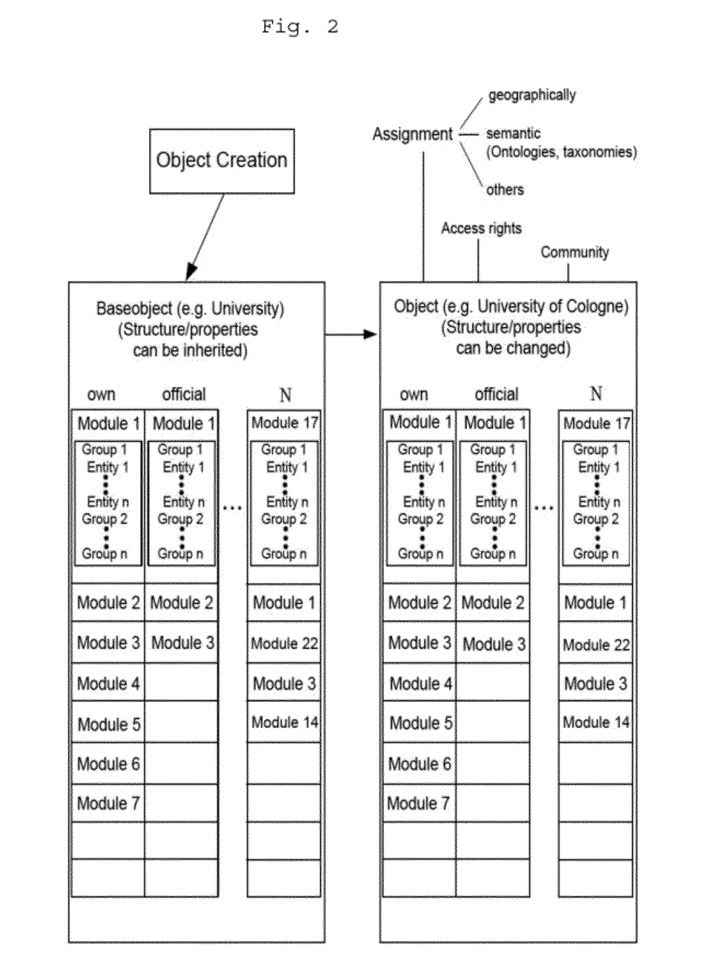

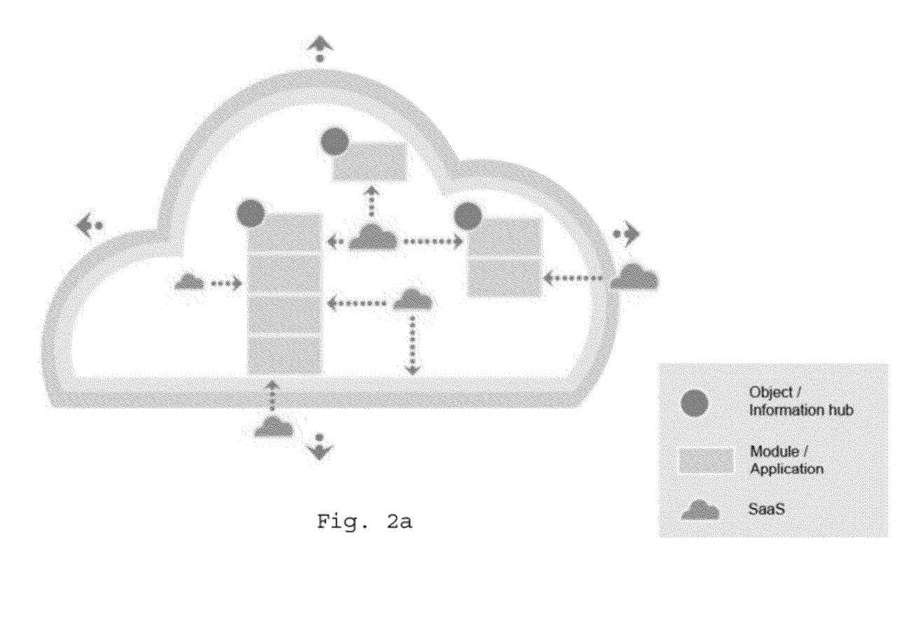

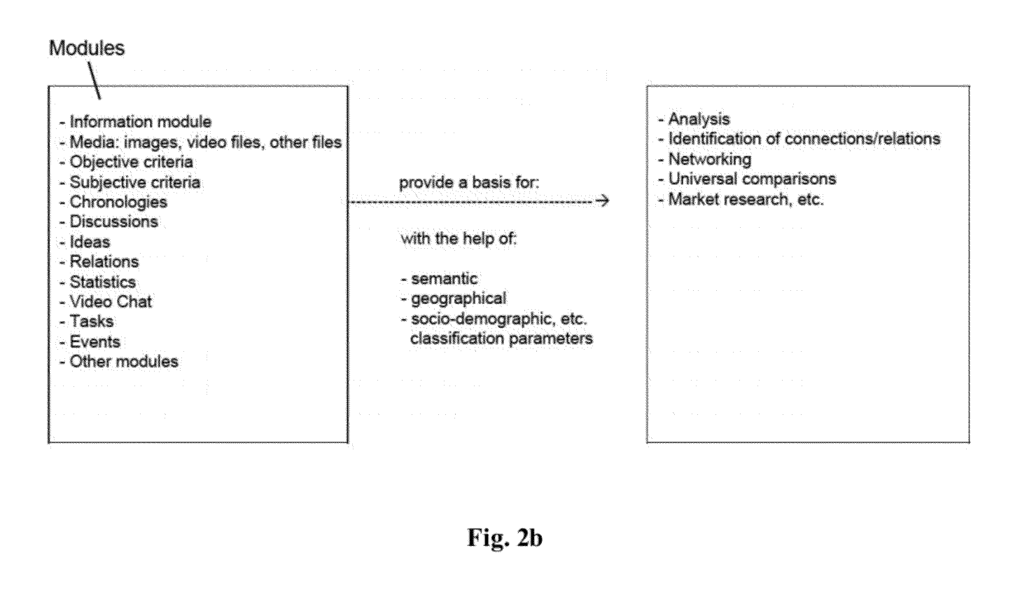

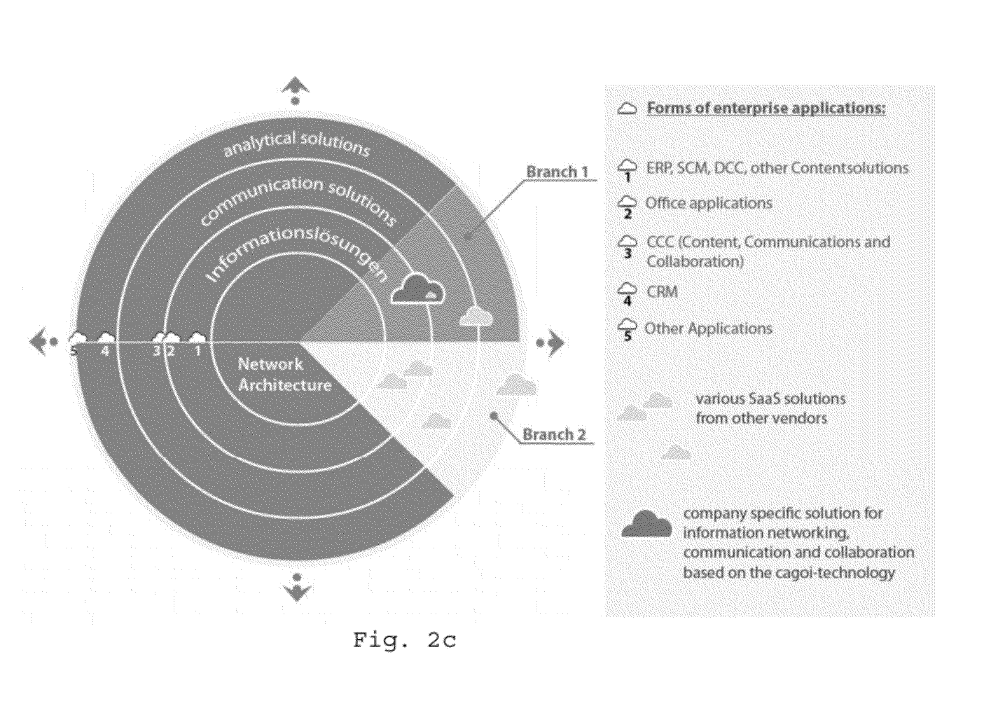

FIG. 1 and FIG. 2 show how the information from a plurality of available data sources in a computer network such as the Internet is or becomes recorded in objects structured in modules as per the invention. In the present case, an object—as previously elaborated—represents an individual and identifiable copy of things, persons or concepts in the real world or the conceptual world, problems and/or decision-making situations. FIG. 1 shows, by way of example, what an object within the meaning of this invention can be, preferably an individual such as a female politician, an actress, an entrepreneur, a show participant or anything of that kind, a real object such as a book, a car or any product, an abstract concept exploring topics such as sustainability, democracy, criminality, tax evasion or anything of that kind, an event such as a political summit, the Olympic Games, the European Football Championships, the Eurovision, or anything of that kind, a relationship between at least two objects such as the differences in size of buildings, a result such as the result of a political reform, the privatisation of the railways, the result of a study, or anything of that kind.

As shown in FIG. 2 in particular, provision has been made for so-called base objects in this illustrative implementation of the invention which enable the user, in particular, to create the objects. In this context, a base object consists primarily of modules and structured information, partly of features or criteria that are common to a specific kind of things, persons or concepts in the real or conceptual world, problems and decision-making situations and can be forwarded or passed on to objects.

At least one property associated with the information is or becomes assigned to the information in the modules of objects, or alternatively, base objects (so-called property assignment). Advantageously, the properties are assigned with regard to geographical classification parameters, semantic classification parameters, socio-demographic classification parameters and/or classification parameters for managing usage rights to information.

The property inheritance, according to the invention, from a base object to an object is advantageously the designation of an inheritance process of a property to be reproduced by means of the resulting family tree which is common to all objects of a similar description. The properties may be changed prior to and following the inheritance by the users (in particular the so-called users or moderators). These changes to the property due to user or moderator activities constitute modifications within the meaning of this invention.

Whereas in other established portals and/or portal applications in the Internet, the properties are usually designated in a static, closed system, to such an extent that an addition or a reduction in properties is not possible, a variable configuration of the objects is ensured in the present case due to the flexible, modular structure of the objects according to the invention. Consequently, it can be proceeded, advantageously, in the process from the object creation right through to the object comparison in a universal and dynamic manner.

### Example

A base object named “university” is examined. Both the objective criteria, especially overall technical and/or physical features and the subjective criteria, especially on the whole the quality of student guidance or the learning environment, for example, provide to the user the subjective interpretations of the properties and/or criteria inherent to the object. They are inherited by all objects with the “University” object type (for example: University of Heidelberg or University of Cologne) and can be further augmented and/or modified by the object creator.

The following advantages result in this regard:
if an additional university is recorded, the objective and the subjective criteria are not required to be re-populated and inputted, in which leads to a considerable saving on time;
furthermore, this results in better comparability of the objects, especially if they are created from base objects.
if numerous universities are created by means of inheritance from the University base object, it is ensured that the most important or most relevant criteria are already designated with the result that, when a university comparison is performed, a relative completeness or consistency in criteria is ensured, resulting in advantageously high-quality comparison queries.

As described in FIG. 2a, an object is at any time both a starting point and a networking point for all relevant information. The functionalities, especially modules and/or applications, serve, according to the invention, to generate knowledge on a specific topic from the distributed information (cf. FIG. 2a). The composition or cooperation from functionalities to modules and from modules to applications outlined in FIG. 2a illustrates the high degree of flexibility of this approach.

A base object serves as a template or sample for any object. Each individual object can, according to the invention, be separated from the base object; in other words, the structure of each individual object can be changed arbitrarily at all times. This flexibility makes the objects ideal starting points for various information, communication and/or analysis solutions according to the invention (cf. in particular FIG. 2b). The particular strength of the solutions according to the invention lies in the fact that the information is supplied in a different form of representation—namely in modules (applications, services). This innovative form of information compression and representation has not been achieved by the known solutions up until now.

In this context, the solution according to the invention distinguishes advantageously between
services that implement elementary information solutions,
services that permit communication solutions within or outside of a company, and
services that represent analysis applications.

Furthermore, the inventive solution is able to distinguish between general services and applications as well as sector- or company-specific services and applications (cf. FIG. 2c). In general, an application is always composed of several modules that cooperate with each other (cf. FIG. 2a).

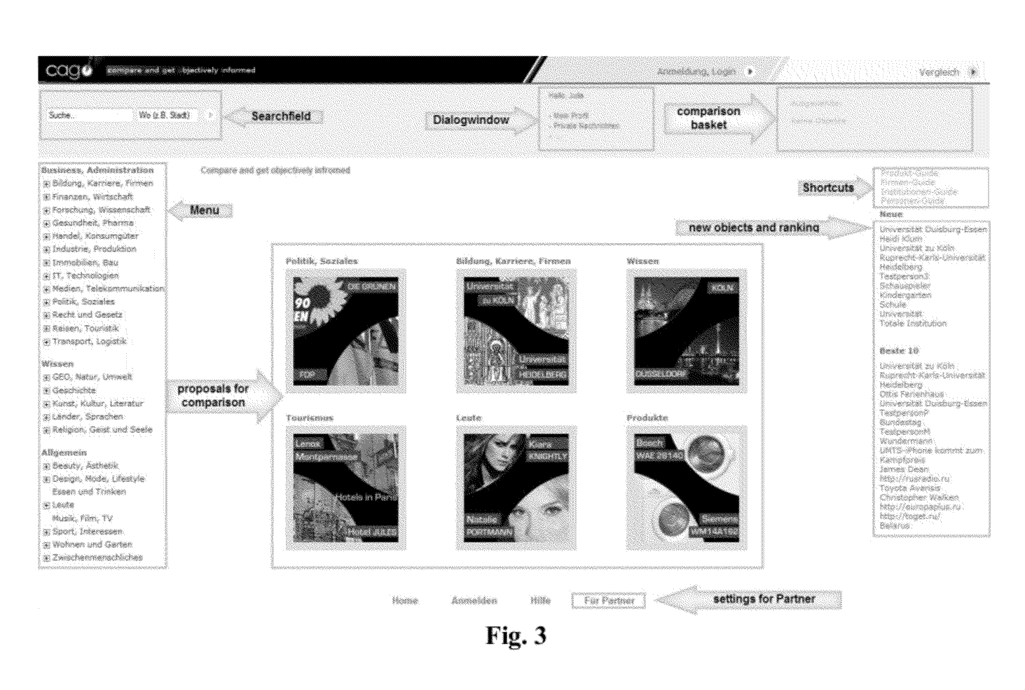

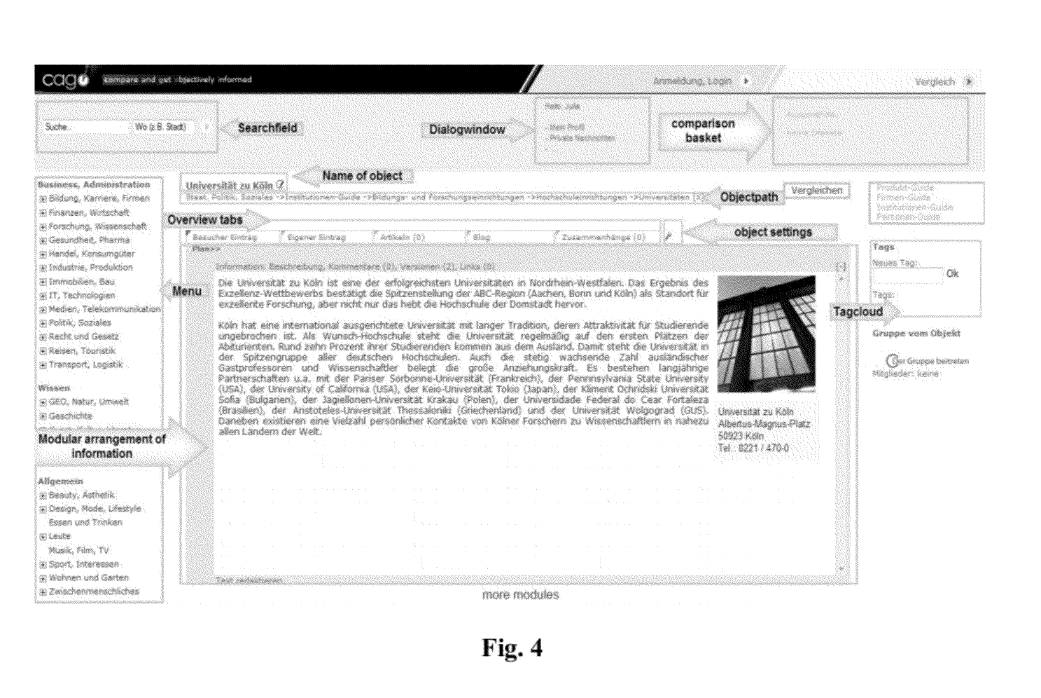

FIG. 3 and FIG. 4 show the setup of a user interface, according to the invention, for the input, output and/or management of the retrieval and/or processing of information, according to the invention, from a plurality of available data sources in a computer network. The functional elements on the side of the user interface according to the invention, referred to in underlined form below, are marked separately in FIGS. 3 and 4 by an arrow bearing the respective names.

The menu user interface is created in the present case advantageously in a tree structure. It comprises universal knowledge or universal themes, all related objects being classified and/or assigned according to the theme and in detail. Before an object can be created, this object must or should be assigned to a menu item. Any number(s) of additional menu assignments can be performed for each object.

For comparison proposals, already defined or interesting comparisons are alternately proposed here. Accordingly, users encounter themes or comparisons that they probably would not have come across on an individual basis. As a result, the user is afforded advantageously a moment of surprise.

The search term is entered in the search field, wherein the query can be, advantageously, restricted if so required.

In the dialogue window, user accounts are registered and set up. This is where personal data or a personal profile is created in the present case. In that connection, a message tool, among others, is available, with which the members can send messages. Furthermore, personal favourites (such as addresses of Internet sites or anything of that kind) can be stored and/or commented on here.

Selected objects that have been chosen for a comparison appear in the comparative basket (comparison selection). The comparison procedure begins once the user clicks on the comparison arrow.

By means of shortcuts one arrives directly at one of the four topics that are often queried by users on the Internet.

The latest object additions are listed in the area of the user interface designated with object additions and ranking. If a single menu item has been selected, the new additions correspond to the selected menu item. The same applies to the ranking. In this context, the objects with top ratings are listed here.

The platform according to the invention can be adopted advantageously by means of the configuration menu for partners. Configuration settings such as own design, logo integration, menu customisation or anything of that kind can be applied advantageously from here.

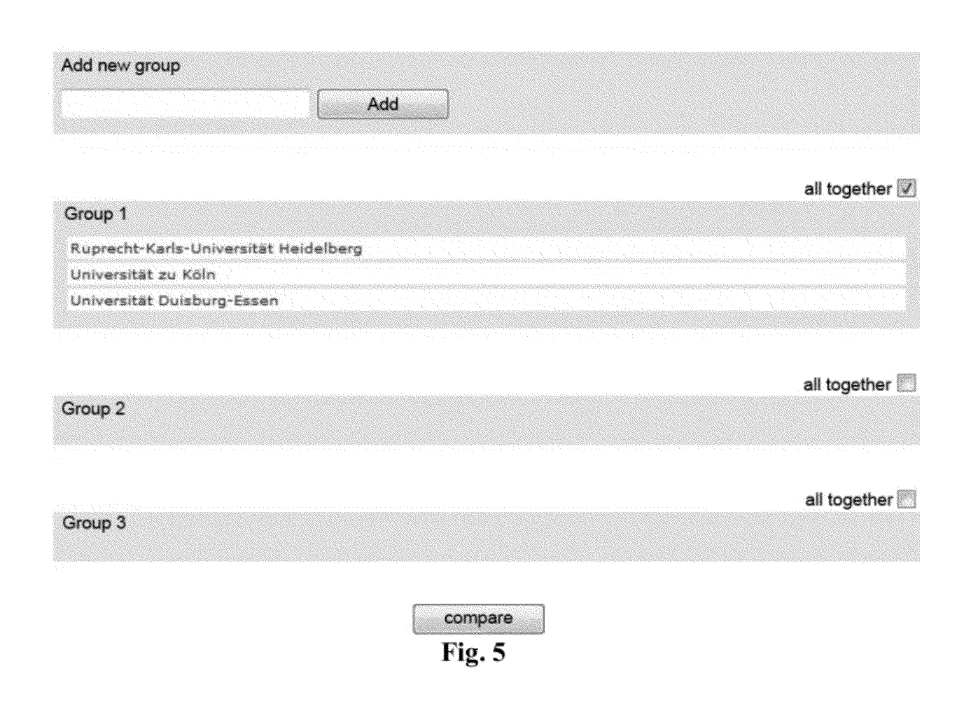

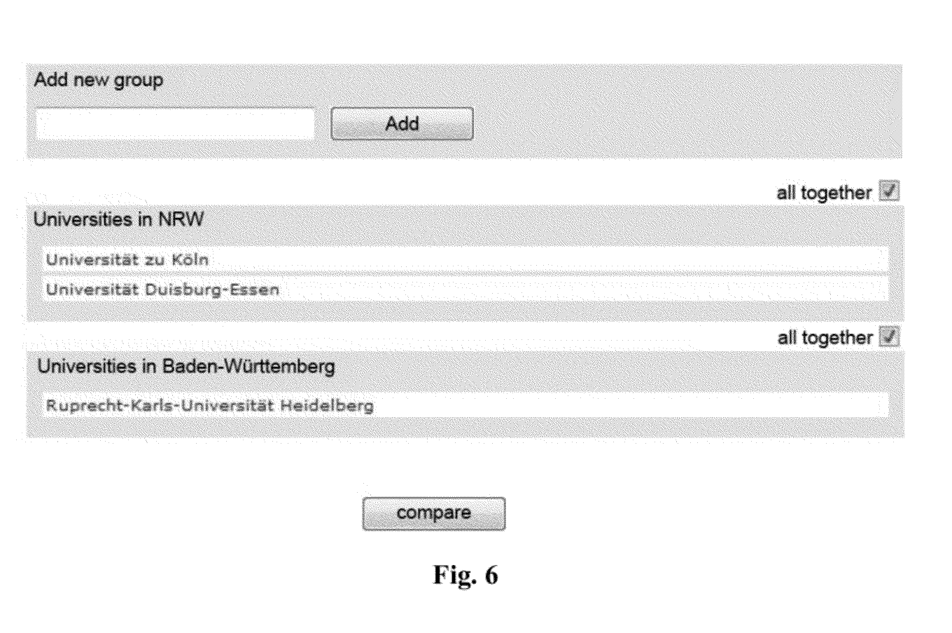

FIG. 5 and FIG. 6 show in a schematic diagram another illustrative implementation example of a user interface according to the invention for the input, output and/or management of the retrieval and/or processing of information from a plurality of available data sources in a computer network in connection with an object comparison according to the invention.

According to the invention, in undertaking an object comparison, objects are selected by so-called “clicking” on the “Compare” button and are placed in the so-called “comparative basket”. In this regard, it is important that users select only objects of a similar description as far as possible, so that similar is compared to similar and the object comparison delivers meaningful results. After the object selection, the side of the user interface, on which the objects of self-defined groups can be assigned, is reached from the comparative basket by clicking on the button designed as an arrow (hereinafter referred to as arrow button)

Assuming that we have selected three objects, in the present case the University of Heidelberg, the University of Cologne, and the University Duisburg-Essen, further individual groupings can be advantageously created from it apart from the comparison of universities in a field, by assigning, for example, the universities in North Rhine Westphalia to an own group and the universities in Baden-Württemberg—to another group (cf. FIG. 6).

In this context, the objects can be shifted advantageously in any way, for example with a mouse or similar input devices within the individual group windows. Advantageously, the number of groups is not limited.

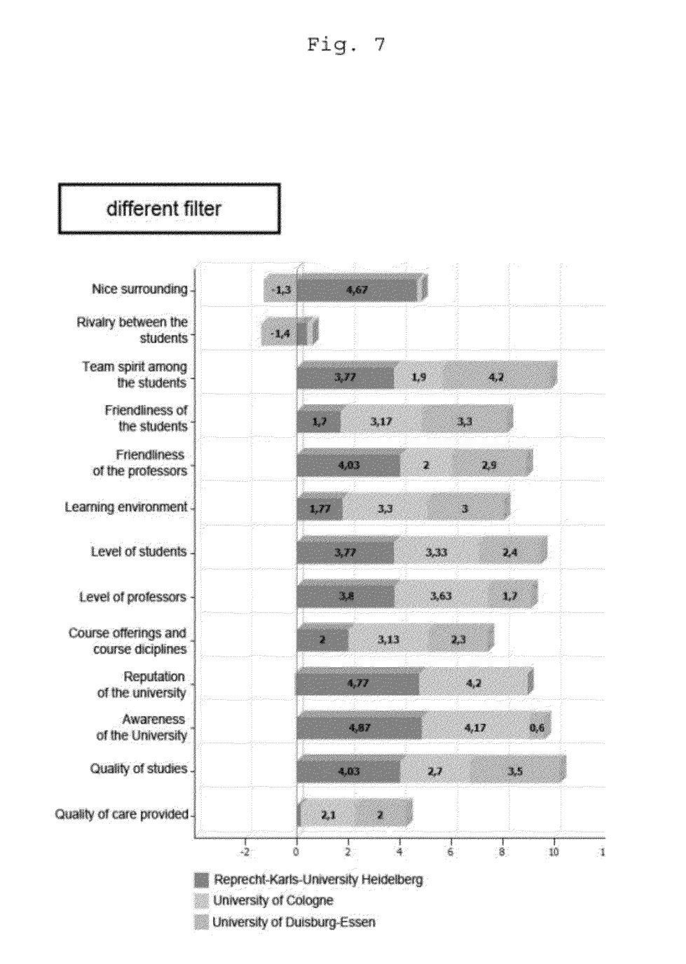

In the present case, there are two ways of making the object comparison:
Individual objects from one or various groups can be compared with each other (cf. FIG. 5).
Groups of objects as a whole can be compared with each other, wherein advantageously the objects are not examined individually according to the invention. For example, this allows for a comparison of the sum total of the universities in North Rhine Westphalia and the universities in Baden-Württemberg. Advantageously, this possibility for comparison in the present case only relates to the subjective criteria (cf. FIG. 6). By clicking on “Compare”, the results are displayed in the form of diagrams and graphs (cf., for example, FIG. 7), advantageously in accordance with the filter settings.

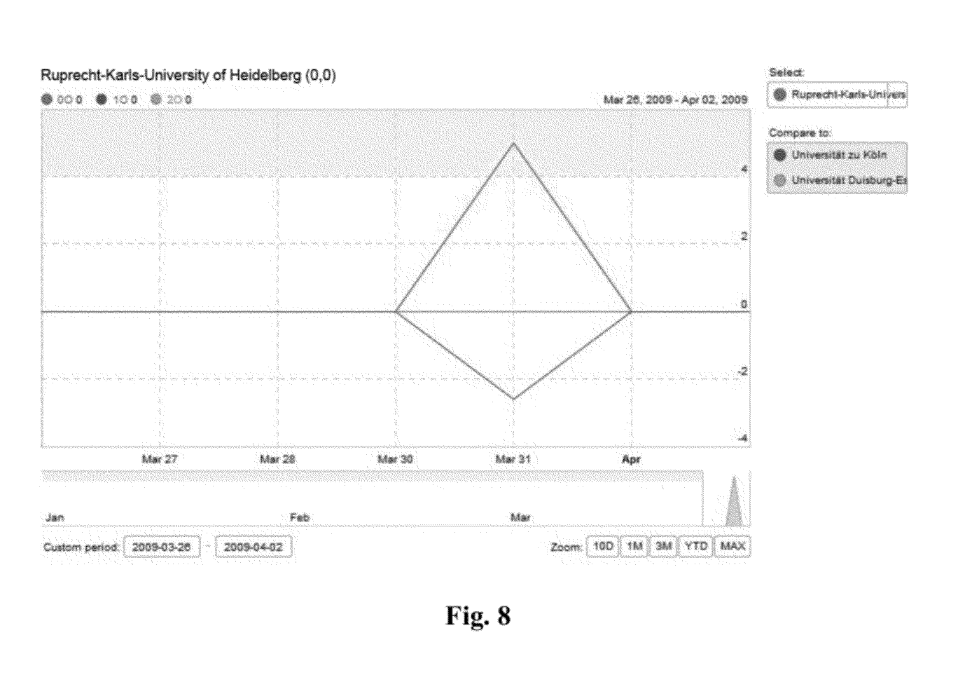

Within the framework of the presentation or reproduction of results according to the invention, as FIG. 7 shows, advantageously both the subjective and objective criteria are described. Furthermore, the presentation of results during time intervals is possible (cf., for example, FIG. 8).

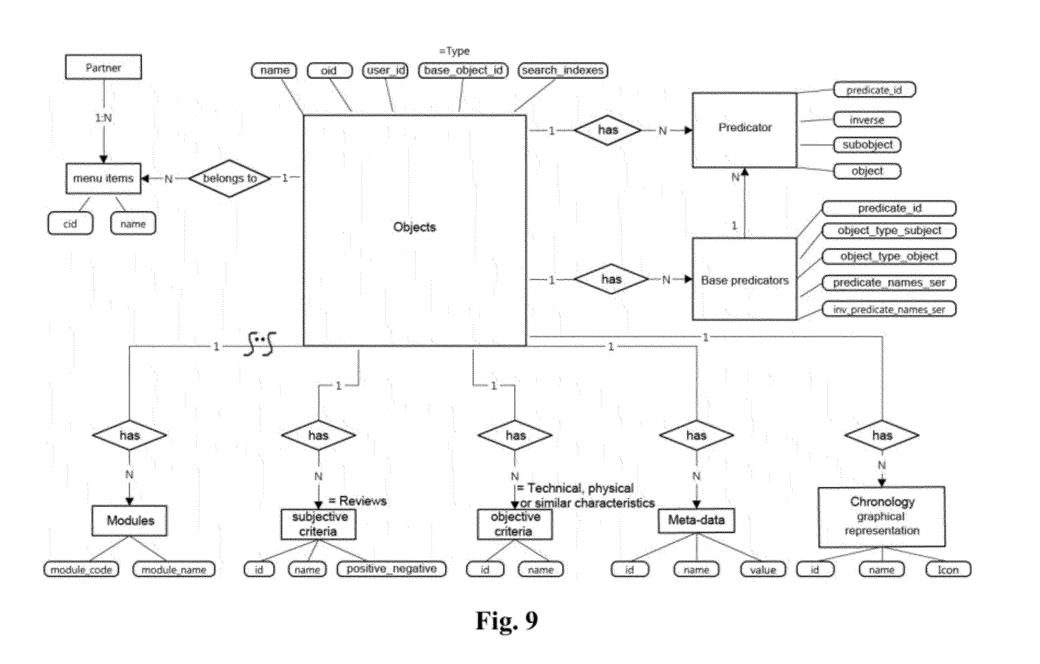

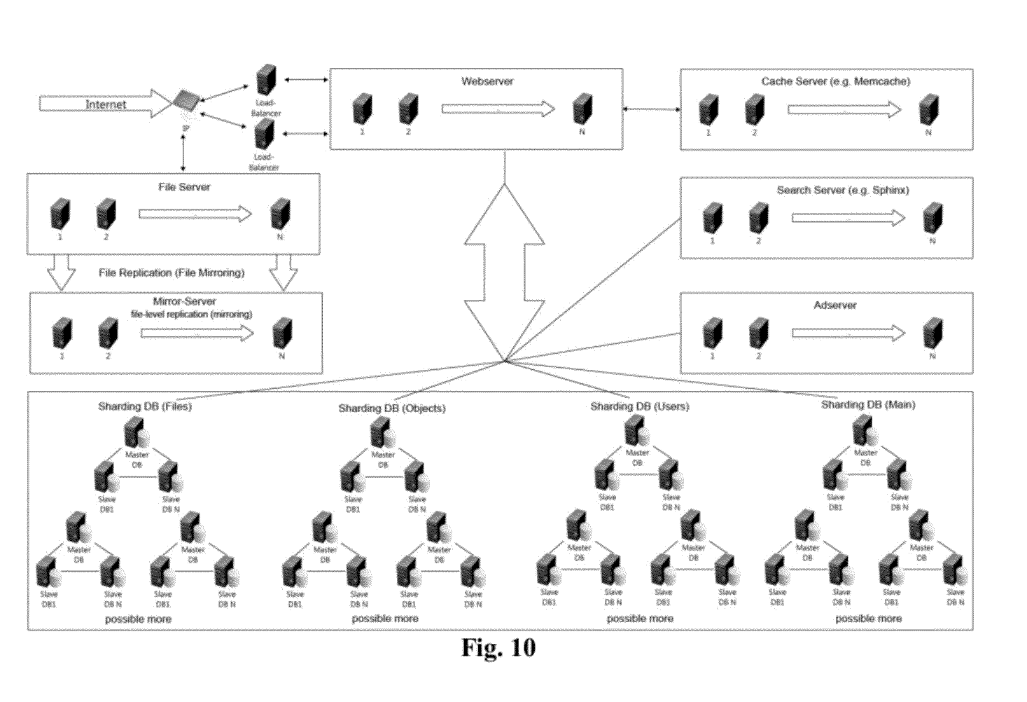

FIG. 9 and FIG. 10 show the structural setup of a data processing system according to the invention for the retrieval and/or processing of information, according to the invention, from a plurality of available data sources in a computer network. FIG. 9 shows the setup of the object structure and the menu navigation of the user interface. FIG. 10 shows the structural setup of the computers and databases of the computer network.

As can be seen in FIG. 9 and FIG. 10, the information recorded in modularly structured objects is stored as object-related data on distributed computers of the computer network. The technical data required for the presentation and management of the object as well as specific properties, features and user-generated data are stored. The data processing system according to the invention ensures advantageously the storage, processing and/or management of any number of objects by virtue of the distributed architecture.

The distributed storage of the object-based data is organised, according to the invention, as follows:
A segment consists of several computers (for reasons of clarity, three computers per segment and a total of three segments per area are presented in FIG. 10, for example). This permits advantageously the load sharing and the data back-up system at the internal segment level. For this purpose, a so-called master-master replication or master-slave replication in particular is applied in the present case (cf. FIG. 10—see designated segment=>applies to all sharding DB's).
Each segment receives one or several intervals assigned and stores the data about, or alternatively, for the objects with the object numbers from this interval. (cf. FIG. 10—see designated segment=>applies to all sharding DB's).
Advantageously, the intervals can be selected in small or large form. With the setting of the interval size, the number of the objects to be stored on the respective segment is changed. This is used in the load sharing. (cf. FIG. 10—see designated segment=>applies to all sharding DB's).
Advantageously, according to the invention, the moving of single objects or a group of objects from one segment to another segment is envisaged. Such a moving can be used advantageously to manage the load sharing. According to the invention, if the object is moved, the object number of the object is retained (cf. FIG. 10—see designated segment=>applies to all sharding DB's).
The information about the assigned intervals of the segments and the information about the objects moved are managed in the present case advantageously by the central node of the data processing system according to the invention (cf. FIG. 10—area sharding DB (Main).

According to the invention, in the case of a distributed architecture of the data processing system, according to the invention, for the retrieving and/or processing, according to the invention, of information from a plurality of available data sources in a computer network, a universal comparison of various objects and/or groups of objects with each other and with themselves is enabled advantageously with respect to the various filter settings and modules. The objects contain modules. The modules contain data assigned to the object and module. In the comparison, the data from the modules selected or defined for the comparison are compared with various procedures defined for the individual modules.

In the present case the modules and/or procedures have the following names and functions:
The information module according to the invention is divided advantageously into two parts. The first part (part 1) contains information, articles, so-called blogs and/or related objects provided by visitors. The second part (part 2) comprises the official information of the respective object. Using the example of the object “University of Cologne”, the University of Cologne is only allowed to present itself here.
In the multimedia module according to the invention, all media-related content and/or formats are combined and/or recalled. The modules objective and subjective criteria ensure advantageously a multi-lingual criteria and/or group recording. Furthermore, the modules objective and subjective criteria ensure the related functions such as record group and/or sort group, evaluation property settings and/or selection options for the object comparison according to the invention.
The discussion module according to the invention ensures advantageously dialogues and/or debates in structured form at the respective discussion point (X1 to Xn) constituting or representing opinions, statements and/or theses, with regard to controlling the direction and the framework (to keep them on “track”), by classifying the respective comments and/or statements on a discussion point (X) advantageously in “pros” and “cons”. By means of the evaluation option (pros and cons), the respective set of opinions per discussion point (X) are visualised advantageously in a graphic form as a percentage.
In the conceptual module according to the invention, suggestions and/or ideas can be put forward and/or commented on. Furthermore, suggestions and/or ideas can be visualised advantageously by means of a graphic application additionally in the form of a diagram or sketch. The ideas are advantageously evaluated by means of the evaluation option “good” or “bad”.
By means of the chronology module according to the invention, all time categories from the minute up to the century periods of time can be represented advantageously on a zoomable timeline. The points in time or the time intervals to be named or selected in each case are recorded advantageously according to topic and/or time, wherein the topics and/or events to be recorded can be positioned and visualised by assigning an icon from a selection list or own icons additionally to the timeline. Any number of chronologies can be created advantageously.
In the relation module according to the invention, objects and/or their relations are presented advantageously on or by a graphic user interface and their relations among each other are shown. The stronger the relation between objects is the stronger or closer a representation of a connection line showing the relations between the respective objects is. In selecting the relational line according to the invention, for example by so-called clicking or clicking on the relational line, relevant information about the relationship of the objects is displayed (for example, object X to object Y). Any number of objects and/or their relations among each other can be shown advantageously. Depending on the object type, the respective object is shown advantageously with an icon corresponding to its category.
By means of the strategy and/or tactic module according to the invention, strategies can be recorded and/or developed in a structured fashion. By using the modules and/or elements, the respective strategy elements can be recorded and evaluated advantageously by means of the so-called scoring process. Furthermore, tactical influences on the strategy can thus also be shown advantageously.

For the object comparison according to the invention, a computer provided and designed as a web server obtains the necessary data from the distributed segmented databases and carries out the module-based comparison according to the invention.

The segments, as described in FIG. 10, can be positioned in various networks, for example within the computer network of a company or a similar establishment. Consequently, the possible privacy policy of a company or a similar establishment can, advantageously, be taken into consideration. As a result, it is ensured advantageously according to the invention that the company or similar establishment has the corresponding data. This option also helps to organise and/or optimise the load sharing of the data processing system according to the invention.

The method and data processing system for automated retrieval and/or processing of information from a plurality of available data sources in a computer network, according to the invention, is used especially advantageously within the framework of a portal or a portal application and has the following advantages and/or features according to the invention:
The portals currently available on the market compare in a rigid structure individual specific “things”, for example products, travels, merchants, etc., whereas according to the invention everything can be compared to each other on the basis of an object-based universal method of comparison
The user has available many optional possibilities to set up a comparison that is interesting from his point of view.
Advantageously, one object can comprise countries. However, advantageously, the collection can be set up at any time in a multilingual mode. If an object has been created in German, then if the same object has to be used at another point in time somewhere abroad or also in the country in another language, then advantageously it does not have to be created again. There are two types of objects: base objects and (normal) objects. Furthermore, there are objective and subjective criteria. They can be developed individually. According to the invention, any extensions and/or modifications are also possible.
The objective criteria, in particular, comprise technical, physical or other similar characteristics, and the subjective criteria such as, for example, the quality of service or the learning atmosphere, give to the user possibilities for a subjective interpretation of the object properties or criteria and can be inherited by the objects from abase object.
Advantageously, the evaluation criteria can be prepared directly or also later in a multilingual mode. In particular, this provides the possibility for international comparability of the information without the need to be able to speak or read other languages.
Advantageously, comparisons at geographical level, in particular at local, regional, national or international level, can be made.
The evaluation frequency can, advantageously, be determined individually in the object.
The objects can be grouped advantageously, with the option for building totals per group, which can then be compared with each other.
The output of the results of the comparison takes place advantageously in the form of diagrams and/or charts. However, it is possible also to make the results available in a tabular form as well as in other creative forms and/or formats.
Advantageously, individual, user-based output of the results is also possible. So the results can be displayed advantageously over a specific period of time.
The differentiation, according to the invention, between the objective comparison criteria and the subjective comparison criteria results, advantageously, in a more useful delivery of the results.

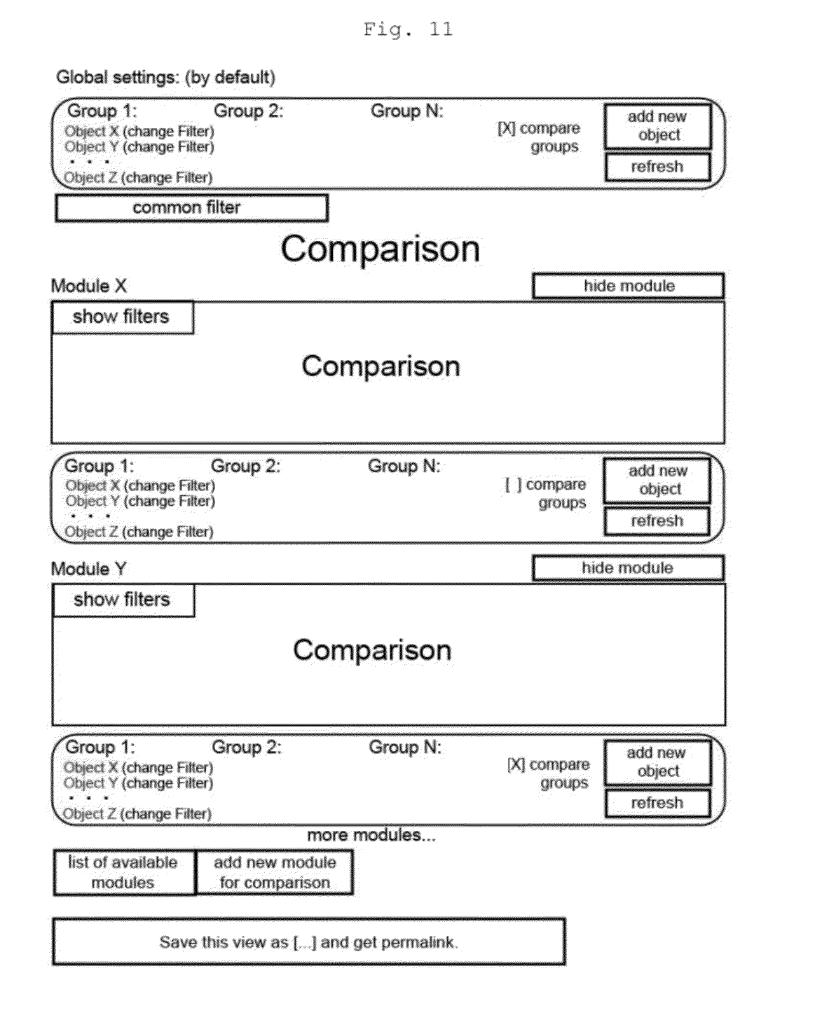

FIG. 11 shows in a schematic diagram an Implementation example the structure, according to the invention, of a comparison according to the invention. Thereby the global settings in the basic configuration of the comparison are related advantageously to all modules which have been selected for the comparison. According to the standards, the modules of the subjective criteria and the modules of the objective criteria are selected. Further modules can be added for the comparison, whereby every separate module can be configured individually. In this way, the universal comparison method is expanded with other functions. The result of the object comparison according to the invention produces a new information product which is provided with an identification code. Third-party Internet sites can access the information product by a link with the code, in particular, to be able to see or call again the results of the comparison at a later point in time without the need to create again the query and the filter setup.

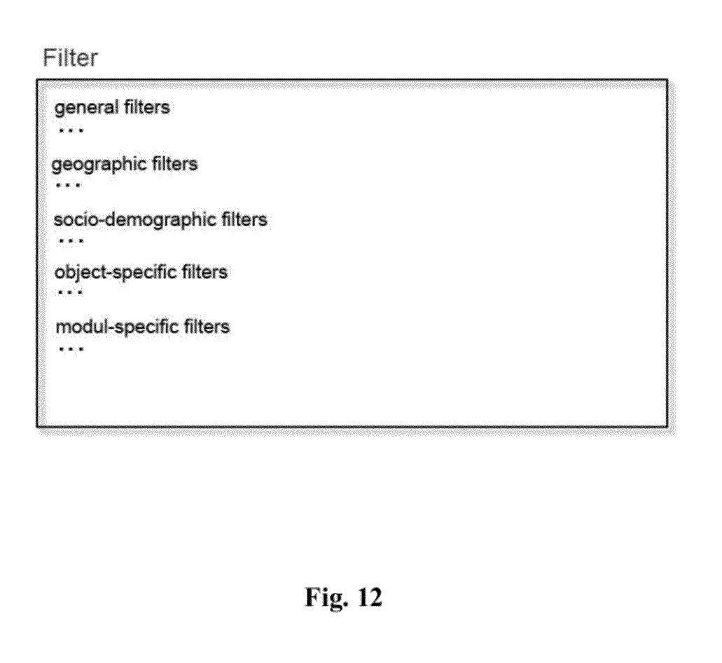

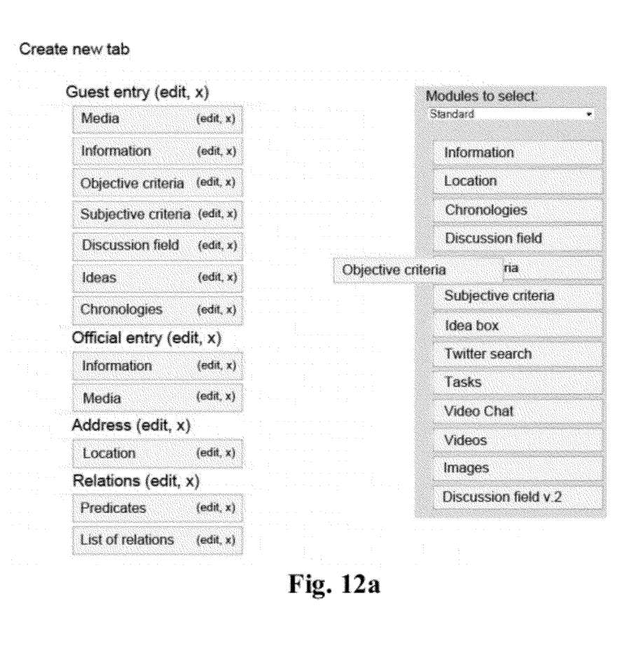

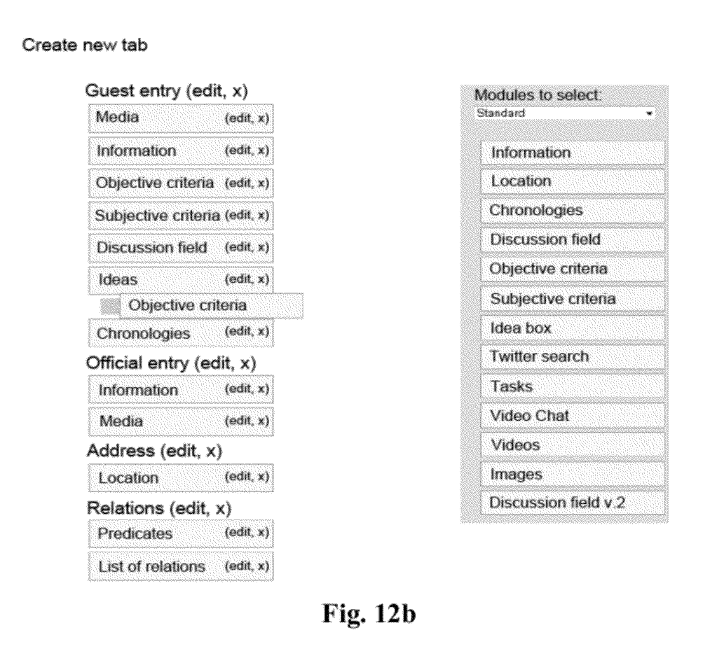

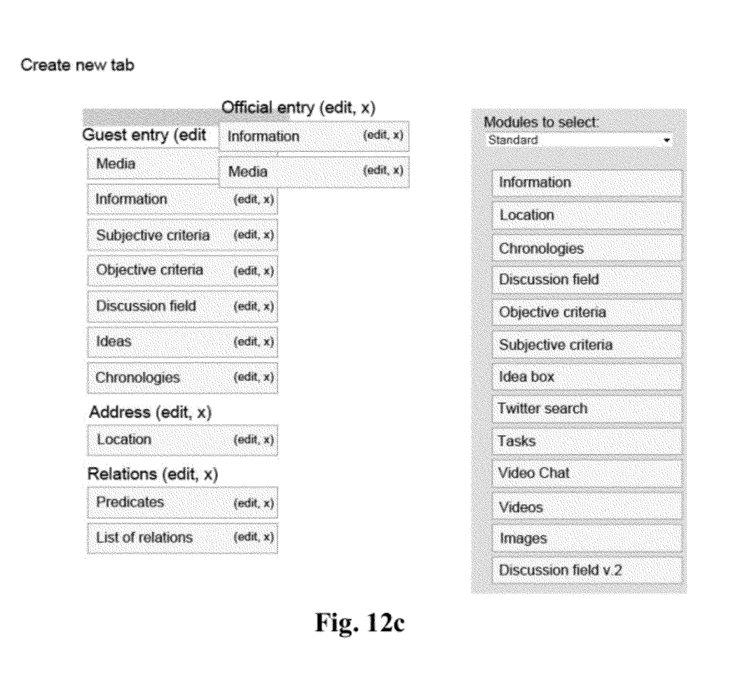

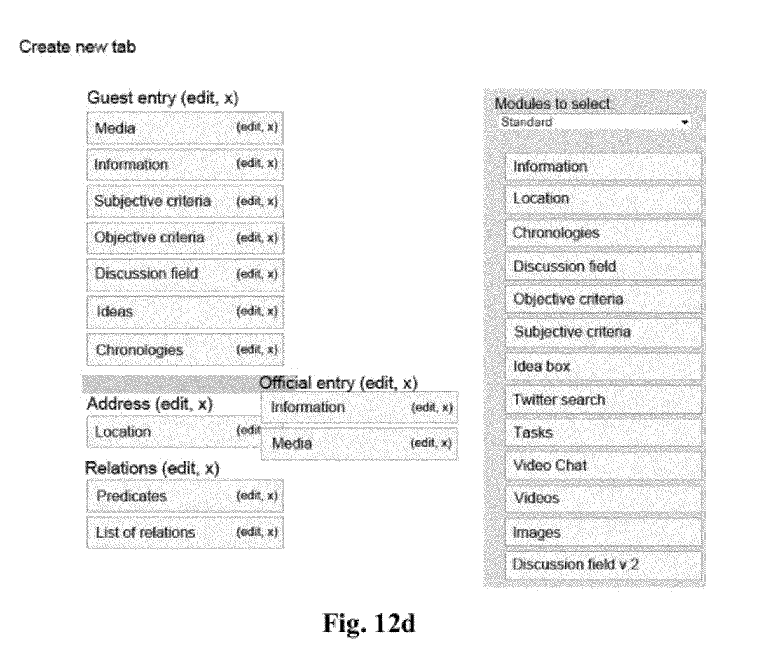

FIG. 12 shows in a schematic diagram an implementation example according to the invention the available filter possibilities and their structuring, including general filters, geographic filters, socio-demographic filters, object-specific filters and/or module-specific filters.

FIG. 12a and FIG. 12b show a schematic implementation example of object creation or object modification according to the invention by means of modules. A modification of an object takes place (cf. in particular, FIG. 2), whereby in a grouped unit of modules (the grouped unit here is “Visitor's input”) a given module (here the “Idea field” module) is extended by an additional module (here by the “Objective criteria” module). FIG. 12a and FIG. 12b show respectively in the left half of the figure the units and modules of the object to be modified. In the right half of FIGS. 12a and 12b, the modules provided for modification of the object are shown for selection. After the choice or the selection of the module to be modified (the left side of FIG. 12a and FIG. 12b) has been made, here the “Idea field” module in the grouped unit “Visitor's input”, and the choice or the selection of the modification to be made from the modules available for selection (the right side in FIG. 12a and FIG. 12b) has been made, here the “Objective criteria” module (cf. FIG. 12a), such one is added to the “Idea field” module in the grouped unit “Visitor's input” (cf. FIG. 12b). The “Idea field” module in the grouped unit “Visitor's input” unit of the object has then a module for “Objective criteria” which is presented as the so-called “new rider”.

FIG. 12c and FIG. 12d show another schematic implementation example for object creation or modification according to the invention by means of modules. In FIGS. 12c and 12d it is shown clearly how in the solution according to the invention the configuration of the rider of a given object, including the associated modules, can be modified by means of the so-called “drag and drop”. Thereby here, from the “Official input” grouped unit, with the modules “Information” and “Media” (cf., in particular, FIGS. 12a and 12b), the corresponding modules are added by “drag and drop” in the grouped unit “Visitor's input” (cf. FIG. 12c) or in the grouped unit “Address” (cf. FIG. 12d).

The implementation examples of the invention presented in the figures of the drawing and discussed in relation to the description serve only for explaining the invention and are, therefore, not limited to them.

1. A method for automated retrieval and/or processing of information from a plurality of available data sources in a computer network, whereby information is input or will be input in objects structured in modules, whereby at least one property related to the information is assigned or will be assigned to the information in the modules of the object, property assignment, a comparison is performed of at least two objects, object comparison, by comparing at least one of the modules of a first object of at least two objects with at least one module of at least one other object of at least two objects, and the result of the comparison of the objects is presented as information.

2. The method according to claim 1, characterised in that an assignment is made of objective and/or subjective properties in a framework of the property assignment.

3. The method according to claim 1, characterised in that information is input in the modules in a grouped unit.

4. The method according to claim 3, characterised in that the object comparison is performed by means of a comparison of at least one group of modules and/or at least one unit of modules, whereby identical groups and/or units of modules are compared with each other.

5. The method according to claim 1, characterised in that the property assignment takes place by taking into consideration geographic classification parameters, semantic classification parameters, socio-demographic classification parameters and/or classification parameters for management of the rights to use the information.

6. The method according to claim 5, characterised in that evaluation criteria are created within a framework of the property assignment in a multilingual mode directly or at a later point in time, preferably in a way that an international comparability of the information is made possible without the need to be able to speak or read the language of the respective country.

7. The method according to claim 1, characterised in that the object comparison can be filtered by taking into account geographic parameters, socio-demographic parameter, object-related parameters, semantic parameters and/or parameters based on expert opinions.

8. The method according to claim 1, characterised in that the result of the object comparison is recorded.

9. The method according to claim 8, characterised in that the result of the object comparison is provided as information, preferably in a graphical form with at least one piece of information in relation to a chronological order and/or association of the information from the object comparison.

10. The method according to claim 1, characterised by a grouping of the objects for the object comparison.

11. The method according to claim 1, characterised in that at least one module at least one information module, at least one multimedia module, at least one module of objective criteria related to the technical and/or physical characteristics, at least one module of subjective criteria, at least one discussion module, at least one ideas module, at least one chronology module, at least one relationships module and/or at least one strategy and/or tactics module are available for the object comparison.

12. The method according to claim 1, characterised in that the information recorded in objects with modular structure is distributed and saved at least partially on different computers, on network computers or network computers pooled in segments, whereby at least one interval with unique object numbers is assigned to each segment, the information recorded in the objects with modular structure is provided with the available unique object numbers, and the objects with modular structure, which are provided with object numbers, are stored by the respective segment, and for performing the object comparison a computer from the computer network, which is designed preferably as a web server, performs an object comparison of the modules by querying the segments, and a result of the object comparison of the modules is stored by the computer from the computer network, which is designed preferably as a web server, and is assembled as object comparison.

13. A data processing system for automated retrieval and/or processing of information from a plurality of available data sources in a computer network, whereby the information is input in objects structured in modules, at least one property related to the information is assigned to the information in the modules of the objects, property assignment, a comparison is performed of at least two objects, object comparison, by comparing at least one module of a first object of at least two objects with at least one of the modules of at least one other object of at least two objects and the result of the object comparison it presented as information.

14. The data processing system according to claim 13, characterised by assignment of objective and/or subjective properties within a framework of property assignment.

15. The data processing system according to claim 13, characterised in that information is recorded in the modules in grouped units.

16. The data processing system according to claim 15, characterised in that the object comparison is performed by comparison of at least one group of modules and/or at least one unit of the modules, whereby identical groups and/or units of the modules are compared with each other.

17. The data processing system according to claim 13, characterised in that the property assignment takes place by taking into consideration geographic classification parameters, semantic classification parameters, socio-demographic classification parameters and/or classification parameters for management of rights to use the information.

18. The data processing system according to claim 17, characterised in that evaluation criteria are created within the framework of the property assignment in a multilingual mode directly or at a later point in time, in a way that an international comparability of the information is made possible without a need to be able to speak or read the language of the respective country.

19. The data according to claim 13, characterised in that the object comparison can take place by taking into account geographic parameters, socio-demographic parameter, object-related parameters, semantic parameters and/or parameters based on expert opinions.

20. The data processing system according to claim 13, characterised in that the result of the object comparison is stored as information.

21. The data processing system according to claim 13, characterised in that the result of the object comparison is presented as information, preferably in a graphical form with at least one piece of information in relation to the chronological order and/or association of the information from the object comparison.

22. The data processing system according to claim 13, characterised by a grouping of the objects for object comparison.

23. The data processing system according to claim 13, characterised in that at least one module, at least one information module, at least one multimedia module, at least one module of objective criteria related to the technical and/or physical characteristics, at least one module of subjective criteria, at least one discussion module, at least one ideas module, at least one chronology module, at least one relationships module and/or at least one strategy and/or tactics module are available for the object comparison.

24. The data processing system according to claim 13, characterised in that the information recorded in objects with modular structure is distributed and saved at least partially on different computers, on network computers or network computers pooled in segments, whereby at least one interval with unique object numbers is assigned to each segment, the information recorded in the objects with modular structure is provided with the available object numbers, and the objects with modular structure, which are provided with object numbers, are stored by the respective segment, and for performing the object comparison a computer from the computer network, which is designed preferably as a web server, performs an object comparison of the modules by querying the segments, and the result of the object comparison of the modules is stored by the computer from the computer network, which is designed preferably as a web server, and is assembled as object comparison.

25. The data processing system according to claim 13, characterised in that it is designed and/or set up to execute at least partially a method for automated retrieval and/or processing of information from a plurality of available data sources in a computer network, whereby information is input or will be input in objects structured in modules, whereby at least one property related to the information is assigned to the information in the modules of the object property assignment, a comparison is performed of at least two objects object comparison by comparing at least one of the modules of a first object of at least two objects with at least one module of at least one other object of at least two objects, and the result of the comparison of the objects is presented as information.
